(19) United States
(12) Patent Application Publication
(10) Pub. No.: US 2012/0213083 A1
(43) Pub. Date: Aug. 23, 2012

(54) HOME NETWORK TEST CIRCUIT

(75) Inventor: Steven K. Shafer, Chittenango, NY (US)

(73) Assignee: JOHN MEZZALINGUA ASSOCIATES, INC., East Syracuse, NY (US)

(21) Appl. No.: 13/031,569

(22) Filed: Feb. 21, 2011

(51) Int. Cl. H04L 12/26

(52) U.S. Cl. 370/241

(57) ABSTRACT

A home network bandwidth diagnostic device includes a housing and a coaxial connector portion secured to the housing. The connector is adapted to electronically couple the diagnostic device to an active distribution port within a subscriber drop system. The diagnostic device further includes a radio frequency injection circuit coupled to the coaxial connector. The radio frequency injection circuit includes a signal injector configured to inject a radio frequency test signal at a first power level substantially to the subscriber drop system. The test signal is defined by a lower home network frequency and an upper home network frequency. The diagnostic device further includes a receiver test circuit having a diplexer circuit coupled to the coaxial connector. An input of the diplexer circuit is configured to accept the radio frequency test signal at a second, lower power level, and an output of the diplexer circuit includes a first test path to pass substantially only the lower home network frequency. The output of the diplexer circuit further includes a second test path to pass substantially only the upper home network frequency. The diagnostic device further includes a first indicator disposed on the first test path and a second indicator disposed on the second test path. The indicators are configured to change state when the second power level is greater than a threshold value. The diagnostic device may be used to determine if sufficient power exists in a subscriber drop system to operate home network-enabled devices, such as MoCA-enabled devices.

### FIELD OF THE INVENTION

This disclosure relates generally to radio frequency home networks and, more specifically, to a diagnostic device for detecting the strength of a home network signal in a subscriber drop system.

### BACKGROUND OF THE INVENTION

In many data distribution networks, electrical signals conveying information propagate along transmission lines across distances and through splitting devices. For example, in a cable television (CATV) network, media content propagates downstream from a head-end facility toward media devices located in various facilities such as homes and businesses. Along the way, the electrical signals conveying the media content propagate along main trunks, through taps, and along multiple branches that ultimately distribute the content to drop cables at respective facilities. The drop cable, which may be a single coaxial cable, typically is connected to a splitting device having two or more outlet ports. Distribution cables connected to the outlet ports route the signals to various rooms, often extending to one or more media devices. The network of distribution cables, splitters, and distribution points is referred to as a drop system.

A typical data distribution network provides many content selections to a user's media devices within the drop system, such as one or more televisions equipped with set top boxes or cable modems. Content selection propagated on a downstream bandwidth of the CATV system may include broadcast television channels, video on demand services, internet data, home security services, and voice over internet (VoIP) services. The content selections are typically propagated in a discrete frequency range, or channel, that is distinct from the frequency ranges of other content selections. Downstream bandwidth includes frequencies typically ranging from 50-1,000 megahertz (MHz).

The typical data distribution network is a two-way communication system. The downstream bandwidth carries signals from the head end to the user and an upstream bandwidth carries upstream signals from the user to the head end. Upstream bandwidth may include data related to video on demand services, such as video requests and billing authorization; internet uploads, such as photo albums or user account information; security monitoring; or other services predicated on signals or data emanating from a subscriber's home. Upstream bandwidth frequencies typically range from 5-42 MHz.

A home network may be coupled to the cable television network via the same coaxial cable delivering the downstream and upstream bandwidth of the CATV system. The home network can be an entertainment network providing multiple streams of high definition video and gaming entertainment. Examples of home networking technologies include Ethernet, HomePlug, HPNA, and 802.11n. In another example, the home network may employ technology standards developed by the Multimedia over Coax Alliance (MoCA). The MoCA standards promote networking of personal data utilizing the existing coaxial cable that is already wired throughout the user premises. MoCA technology provides the backbone for personal data networks of multiple wired and wireless products including voice, data, security, home heating/cooling, and video technologies. In a MoCA network, the cable drop from the cable system operator shares the coaxial line or network connection with MoCA-certified devices such as a broadband router or a set top box. The home users utilize coaxial wiring already existing within the home or business to interconnect the wired and wireless MoCA devices by directly connecting them to the coaxial jacks throughout the premises. MoCA technology delivers broadband-caliber data rates exceeding 130 Mbps, and supports as many as sixteen end points.

A MoCA-certified device such as the broadband router interconnects other MoCA-certified components located within the premises, for example additional set top boxes, routers and gateways, bridges, optical network terminals, computers, gaming systems, display devices, printers, network-attached storage, and home automation such as furnace settings and lighting control. The home network allows distribution and sharing of data or entertainment content among the MoCA-connected devices. For example, a high definition program recorded on a set top box in the living room may be played back by a second set top box located in a bedroom. And, a high definition movie recorded on a camcorder and stored on a user's personal computer may be accessed and displayed through any of the set top boxes within the premises. The home network may also allow high-definition gaming between rooms.

The home network may utilize an open spectrum bandwidth on the coaxial cable to transmit the personal data content. In most coaxial CATV systems, the open spectrum bandwidth includes an unused upper frequency range. For example, a cable system operator may utilize a bandwidth of frequencies up to 1002 MHz. The open spectrum bandwidth may therefore include 1002-1550 MHz. In another example, the cable system operator may utilize a bandwidth of frequencies up to 870 MHz and the open spectrum bandwidth may include 870 MHz to 2000 MHz. In one particular example, the Multimedia over Coax Alliance specifies an open spectrum, or home network bandwidth, of 1125-1525 MHz. A home network utilizing the open spectrum bandwidth does not interfere with any of the bandwidth being utilized by the cable television or satellite services provider.

### SUMMARY OF THE INVENTION

In one aspect of the invention, a one-piece home network bandwidth diagnostic device includes a housing and a coaxial connector portion secured to the housing. The connector is adapted to electronically couple the diagnostic device to an active distribution port within a subscriber drop system. The diagnostic device further includes a radio frequency injection circuit coupled to the coaxial connector. The radio frequency injection circuit includes a signal injector configured to inject a radio frequency test signal at a first power level substantially to the subscriber drop system. The test signal is defined by a lower home network frequency and an upper home network frequency. The diagnostic device further includes a receiver test circuit having a diplexer circuit coupled to the coaxial connector. An input of the diplexer circuit is configured to accept the radio frequency test signal at a second, lower power level, and an output of the diplexer circuit includes a first test path to pass substantially only the lower home network frequency. The output of the diplexer circuit further includes a second test path to pass substantially only the upper home network frequency. The diagnostic device further includes a first indicator disposed on the first test path and a second indicator disposed on the second test path. The indicators are configured to change state when the second power level is greater than a threshold value.

In another aspect of the invention, a two-piece home network bandwidth diagnostic device includes a first housing comprising a coaxial connector portion adapted to electronically couple a radio frequency injector circuit to a first distribution port within a subscriber drop system. The radio frequency injector circuit is configured to inject a radio frequency test signal at a first power level to the first distribution port. The test signal is defined by a lower home network frequency and an upper home network frequency. The first housing further includes a power switch coupled to the radio frequency injection circuit for transmitting the test signal.

The two-piece diagnostic device further includes a second housing comprising a coaxial connector portion adapted to electronically couple a receiver test circuit to a second distribution port within the subscriber drop system. The receiver test circuit includes a diplexer circuit coupled to the coaxial connector portion. An input of the diplexer circuit is configured to accept the radio frequency test signal at a second, lower power level, and an output of the diplexer circuit includes a first test path to pass substantially only the lower home network frequency, and a second test path to pass substantially only the upper home network frequency. The receiver test circuit further includes a first indicator disposed on the first test path and a second indicator disposed on the second test path. The indicators are configured to change state when the second power level is greater than a threshold value.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 shows a simplified schematic view of a CATV network according to one embodiment of the invention;

FIG. 2 is a chart showing the insertion loss across the input port and outlet port of a splitter within the CATV network of FIG. 1;

FIG. 3 shows a perspective view of an exemplary diagnostic device according to one embodiment of the invention;

FIG. 4 shows a circuit diagram for the diagnostic device of FIG. 3;

FIG. 5 shows a perspective view of an exemplary diagnostic device according to another embodiment of the invention; and

FIG. 6 shows a circuit diagram for the diagnostic device of FIG. 5.

### DETAILED DESCRIPTION OF THE INVENTION

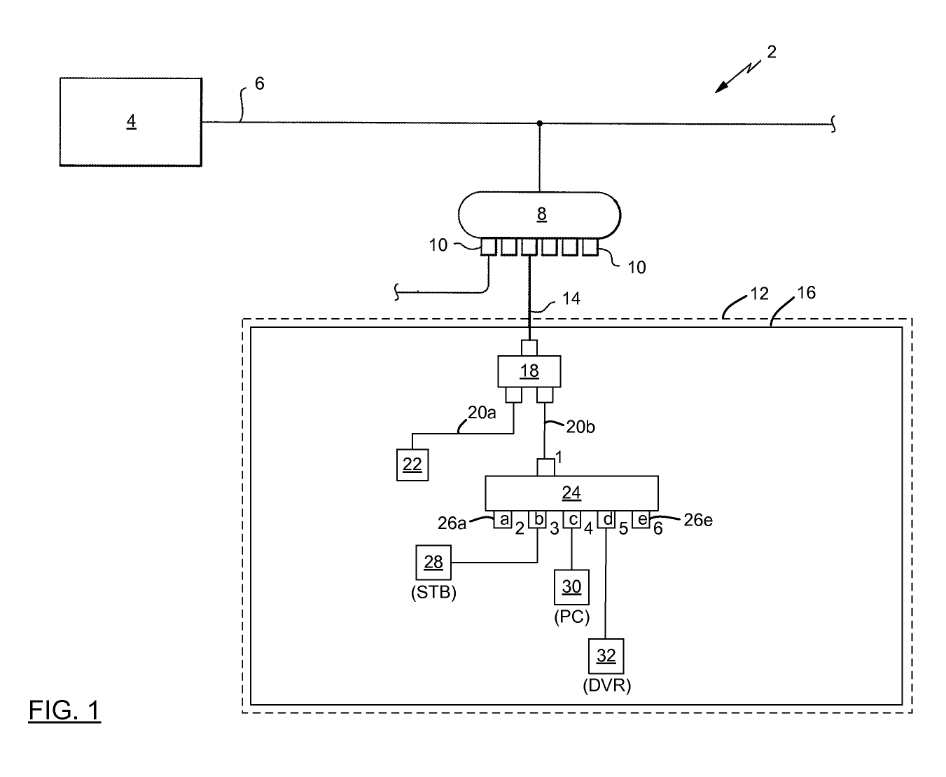

Recent testing with existing coaxial drop systems utilizing the open spectrum bandwidth for home networking revealed that significant insertion losses occur in the upper range of frequencies for conventional devices such as filters, splitters, and amplifiers. This concept may be explained with reference to FIG. 1, in which a portion of a CATV or cable television network 2 includes a head end facility 4 for processing and distributing signals over the network. Typically the head end facility 4 is controlled by a system operator and includes electronic equipment to receive and re-transmit video and other signals over the local cable infrastructure. One or more main distribution lines 6 carry the downstream bandwidth from the head end facility 4 to a tap 8 configured to serve a local distribution network of about 100 to 500 end users, customers, or subscribers. The tap 8 includes a plurality of tap ports 10 that are configured to carry the downstream bandwidth to a subscriber drop system 12 via a drop cable 14, which may be a single coaxial cable.

The drop cable 14 typically enters a subscriber's premises 16 and connects to one or more splitters such as a first splitter 18. A first branch 20a may be connected to a first customer premises equipment device 22 such as an embedded multimedia terminal adapter (eMTA). The eMTA combines a high-speed data cable modem with voice-over-Internet Protocol technology to create a platform that connects legacy telephones and terminal equipment (e.g., fax) to the cable operator's advanced Internet protocol communications network. A second branch 20b may be connected to a second splitter 24.

In one embodiment, the second splitter can be a video distribution panel. In FIG. 1, the second splitter 24 is a five-way splitter having five distribution ports 26a through 26e. Port 26a is shown as an open port; meaning there is no device connected to it. Coaxial cable connects port 26b to a second customer premises equipment device 28, which may be set top box (STB), for example. Port 26c is shown connected to a home network-enabled personal computer 30. As used herein, a home network-enabled device distributes high-quality multimedia content and high-speed data on existing coaxial cable in a frequency range outside of the cable/satellite operator's bandwidth. In one example, the personal computer 30 is a MoCA-enabled device that is configured to distribute home-networking content over a plurality of channels in the 870 MHz to 2000 Mhz frequency range. Coaxial cable connects port 26d to a third customer premises equipment device 32, which in one example is a home network-enabled digital video recorder (DVR), such as a MoCA-enabled DVR. Port 26e is also shown as an open port.

In the illustrated subscriber drop system 12, the MoCA-enabled DVR 32 may be configured to digitally record high definition content originally distributed by the cable provider in the provider bandwidth, then at a later time distribute that content in the home networking bandwidth to the MoCA-enabled personal computer 30.

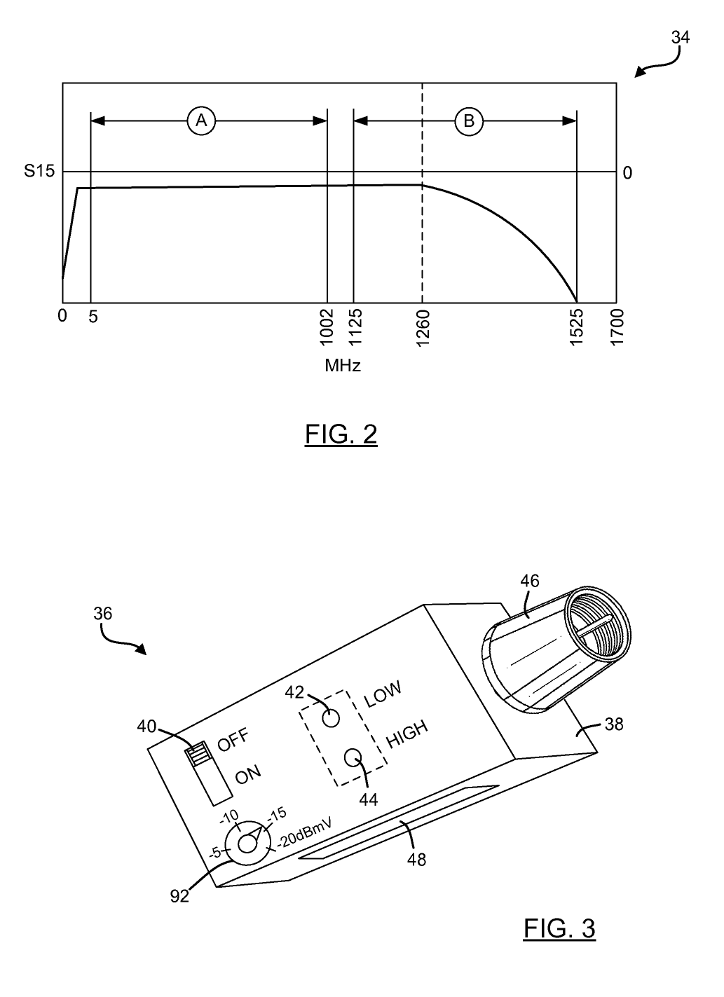

Insertion loss refers to the loss of signal power resulting from the insertion of a device, such as the first or second splitter 18, 24 respectively, in the transmission line. The insertion loss value is a negative logarithmic number expressed in decibels (dB) however, as used herein, the negative sign is dropped. As a rule of thumb, a 3 dB insertion loss reduces transmission power to one half, 10 dB reduces transmission power to one tenth, 20 dB to one hundredth, and 30 dB to one thousandth. Therefore, the greater the insertion loss across the device, the less energy that is passing through the circuit. Referring to FIG. 2, there is shown a plot 34 of the insertion loss across the input port 1 and outlet port 5 of the second splitter 24 (FIG. 1). The vertical axis represents insertion loss in decibels (dB). The horizontal axis represents a portion of the radio frequency (RF) spectrum from 0 MHz to 1700 MHz. The portion of the trace labeled “A” depicts the insertion loss for a conventional splitter in the CATV spectrum of frequencies (e.g., 5 MHz to 1002 MHz); the insertion loss value is typically 3 dB to 5 dB. The portion of the trace labeled “B” depicts the insertion loss for a conventional splitter in the home network spectrum of frequencies (e.g., 1125 MHz to 1525 MHz). In the illustrated example, the insertion loss begins to “roll off” at approximately 1260 MHz, and may exceed 20 dB in the upper range of the home network band (e.g., 1525 MHz). This roll-off limits the number of channels that can be utilized in the home networking band. In the illustrated example, data propagated on channels having frequency ranges greater than 1260 MHz would suffer significant power loss, resulting in loss of data transmission.

The provider of the downstream bandwidth provides enough power (voltage) in the coaxial line to account for some losses throughout a user's drop system. General industry standards recommend approximately −15 to +15 decibel millivolts (dBmV) in the coaxial line, where 0 dBmV represents an industry-standard reference value for the minimum voltage required by an analog television tuner to produce an excellent television picture. Depending on the particular drop system architecture, some amount of power loss in the home network frequency range may be tolerated. In general, the higher the voltage value at the point of entry of a user premises, the greater amount of loss that can be tolerated. Modern day digital tuners and home network-certified devices such as MoCA-certified devices require a minimum voltage in the coaxial cable for the device to work properly. Expressed in decibel millivolts (dBmV), the minimum voltage value varies from device to device and manufacturer to manufacturer, but typical minimum values are −15 dBmV to −10 dBmV. Thus, even though some insertion losses occur in a drop system due to the presence of splitters and the like, the remaining power in the coaxial line at the input of the home network-certified device may be sufficient to prevent any loss of data. In addition, if there are not many channels being utilized by the home network-certified device, the roll-off as depicted in FIG. 2 may not affect the channels currently being used.

The current problem many consumers experience is that there is no simple device or method available to help them determine whether a particular home network-certified device will properly function within their existing drop system. That is, the average home user wishing to install a system that distributes home networking bandwidth into their existing coaxial network, such as a MoCA-enabled devices, cannot determine if sufficient power is present in the coaxial connection at the inlet port of the home network-enabled device. Meters are commercially available to perform this function, but they are expensive, complicated, and require a certain degree of expertise to use properly. Further, there is no simple device or method to determine whether the insertion losses attributed to the existing devices in the coaxial network would collectively attenuate the home networking bandwidth. And, even if a portion of the home networking bandwidth is attenuated, there is no simple device or method to determine whether the attenuation is severe enough to negatively impact the proper transmission and reception of data over the home networking bandwidth.

Referring to FIG. 3, an exemplary diagnostic device 36 is illustrated that overcomes the described deficiencies. The device 36 includes a one-piece hand-held housing 38 with a power switch 40 and two LED indicator lights 42, 44 respectively. The power switch 40 enables the user to activate the diagnostic device 36 and transmit a test signal, as will be explained below. In one embodiment, the power switch 40 is a selector having ON and OFF positions. In another embodiment, the power switch 40 is an ON-OFF button. In yet another embodiment, the power switch 40 is controlled by internal electronics and remains in the ON position. The housing 38 can be formed of a hard impact-resistant material, plastic or polymer, or a hard electrically insulating material. A coaxial connector 46 electronically couples the diagnostic device 36 to an active distribution port within the subscriber drop system 12, such as an outlet port of the first splitter 18 or the second splitter 24 (FIG. 1). The illustrated connector 46 is a male cable connector, but one of ordinary skill in the art can readily construct a connector having alternate configurations for electrically coupling to an active port. The housing 38 may further include an access panel 48 to a power supply, such as a battery compartment.

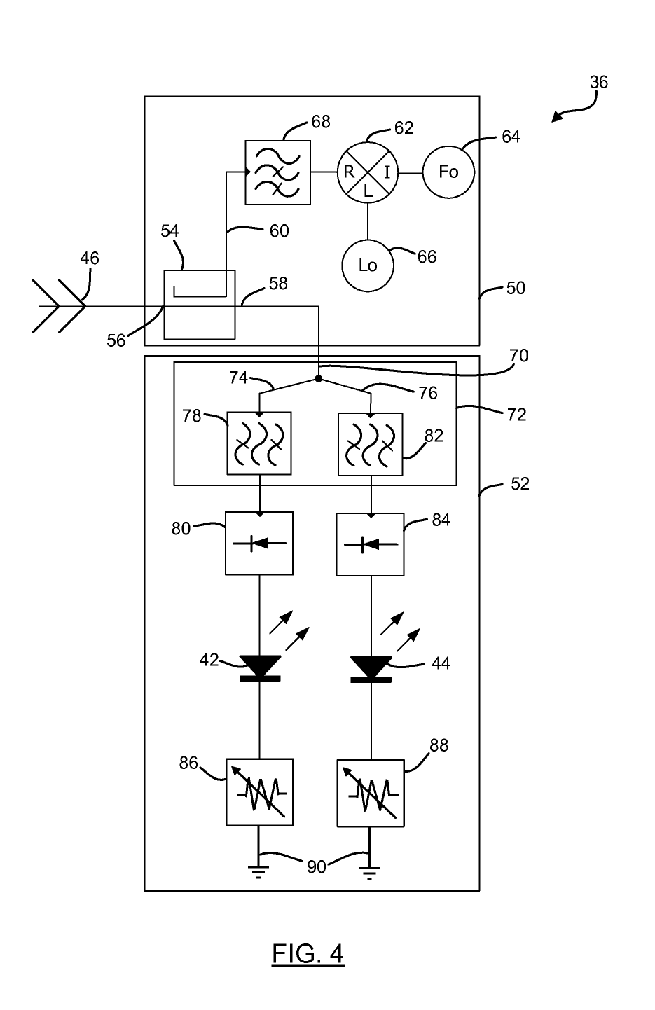

The first indicator 42 and the second indicator 44 may be more fully understood with reference to the schematic circuit diagram in FIG. 4, wherein one embodiment of the diagnostic device 36 includes a radio frequency injection circuit 50 and a receiver test circuit 52. The radio frequency (RF) injection circuit 50 includes the coaxial connector 46 coupled to a signal injector 54. In the disclosed embodiment, the signal injector 54 is a three-port directional coupler. In conventional terms, the input port 56 of the coupler receives RF signals from the connector 46 while the through port 58 transmits the RF signals to the receiver test circuit 52. A test signal may be injected at a coupled port 60 of the signal injector 54. The test signal is generated at signal generator 62 that is arranged and configured to output an RF signal that includes the home network bandwidth. In one embodiment, the signal generator 62 is a mixer wherein two input signals 64 and 66 are multiplied and the high frequency output signal passes through a high pass filter 68. One skilled in the art would appreciate that more than two inputs may be utilized in order to obtain the desired RF signal output in the home network bandwidth. The high pass filter 68 is configured to pass only the home network frequency range and attenuate any frequencies below the home network frequency range. In one example, the first input signal 64 to the mixer 62 is approximately 1545 MHz (or a multiple thereof), and the second input signal 66 is approximately 440 MHz, and the high pass filter 68 passes RF signals in a range from 1125 MHz to 1525 MHz. The filtered signal passes to the coupled port 60 of the signal injector 54, and in one example 20 dB to 30 dB of the signal is coupled, or injected, to the input port 56 and propagates in an upstream direction out through the connector 46.

The injected signal is reflected at an upstream port, as will be explained in detail below. The reflected signal propagates in a downstream direction back through the connector 46, through the input port 56 and the through port 58, and passes to an inlet port 70 of the receiver test circuit 52. The receiver test circuit 52 includes a diplexer circuit 72 configured to split the incoming signal from the inlet port 70 to a first test path 74 and a second test path 76. The diplexer circuit 72 includes a first band pass filter 78 disposed on the first test path 74. The first band pass filter 78 is configured to pass only the frequencies on the low end of the home network bandwidth. For example, the first band pass filter 78 may pass frequencies in the range of 1000 MHz to 1125 MHz. The output of the first band pass filter 78, if present, is connected to a first rectifier 80, such as a log detector or peak detector, for conversion to a direct current (DC) signal, or voltage. The DC signal changes the state of the first indicator 42 if the voltage is greater than a threshold value. The threshold value represents the lower range of the home network bandwidth in the signal that was reflected from an upstream port that is sufficient to operate a home network-enabled device. In one example, the first indicator 42 is a light-emitting diode (LED), and the threshold value may be in a range from −20 to 0 decibel millivolts (dBmV), as will be explained below. Note that the use of a directional coupler as the signal injector 54 prevents the injected signal at the coupled port 60 from propagating out the through port 58 in a downstream direction towards the receiver test circuit 52.

The incoming signal from the inlet port 70 also propagates along the second test path 76 in the diplexer circuit 72 to a second band pass filter 82. The second band pass filter 82 is configured to pass only the frequencies on the upper range of the home network bandwidth. For example, the second band pass filter 82 may pass frequencies in the range of 1525 MHz to 1600 MHz. The output of the second band pass filter 82, if present, is coupled to a second rectifier 84, such as a log detector or peak detector, for conversion to a DC signal. The DC signal changes the state of the second indicator 44 if the voltage is greater than a threshold value. The threshold value represents the upper range of the home network bandwidth in the signal that was reflected from an upstream port that is sufficient to operate a home network-enabled device. In one example, the second indicator 44 is a light-emitting diode (LED) and the threshold value may be in a range from −20 dBmV to 0 dBmV.

Referring now to FIGS. 1, 3, and 4, the operation of one embodiment of the diagnostic device 36 will be explained. To test whether a home network device (such as a MoCA device) will operate at a particular distribution port, the connector portion 46 of the diagnostic device is connected to the cable port in the subscriber drop system 12, such as distribution port 26e. When the diagnostic device is powered on, a test signal is generated as described hereinabove and injected at a first power level and propagates through the cable port. In one example, the first power level approximates the signal strength of the cable provider's downstream bandwidth (e.g., −15 to +15 dBmV). The test signal propagates the range of frequencies in the home network bandwidth. As the test signal propagates through the drop system, it reflects off devices and components in the coaxial line, thereby decreasing the initial power level. The reflected signal propagates back towards the connector portion 46 of the diagnostic device 36 and enters the diplexer circuit 72 at a second, lower power level. In one example, the reflected signal reflects off a shorted port such as distribution port 26a. In another example, the reflected signal reflects off a terminated port such as distribution port 26b.

The rectifiers 80, 84 in the receiver test circuit 52 convert the specific frequencies of the home networking bandwidth into a low level voltage indicative of the voltage required to operate the home network device. The threshold voltage required to operate the device will change the state of the indicators 42, 44. In one example, the manufacturer of the home network device specifies at least −20 dBmV is required to operate the device. The indicators 42, 44 will change state (e.g., illuminate LEDs) if there is more than a −20 dBmV potential across the indicators.

The diagnostic device of the present invention can be adapted to test for different voltage values. This feature is particularly useful when several devices are connected to the home network system. For example, a home network-enabled digital video recorder may require −10 dBmV to operate properly, and a home network-enabled set top box may require −15 dBmV to operate properly. To distinguish between operational threshold voltage values, the first test path 74 and the second test path 76 may include variable resistor elements 86, 88 respectively disposed adjacent the ground 90. The resistance setting may be referenced to the desired threshold voltage value. An external selector 92 on the housing 38 allows the diagnostic device 36 to be set for a particular voltage by varying the resistance values. In another embodiment, the selector 92 may be utilized to detect the threshold (i.e., minimum) voltage available to the distribution port of the splitter. For example, the device 36 may be used to ascertain whether the entire home network bandwidth is available at −5 dBmV at the splitter port, or a value much less, such as −20 dBmV. In either example, an affirmative result would illuminate both indicators 42, 44.

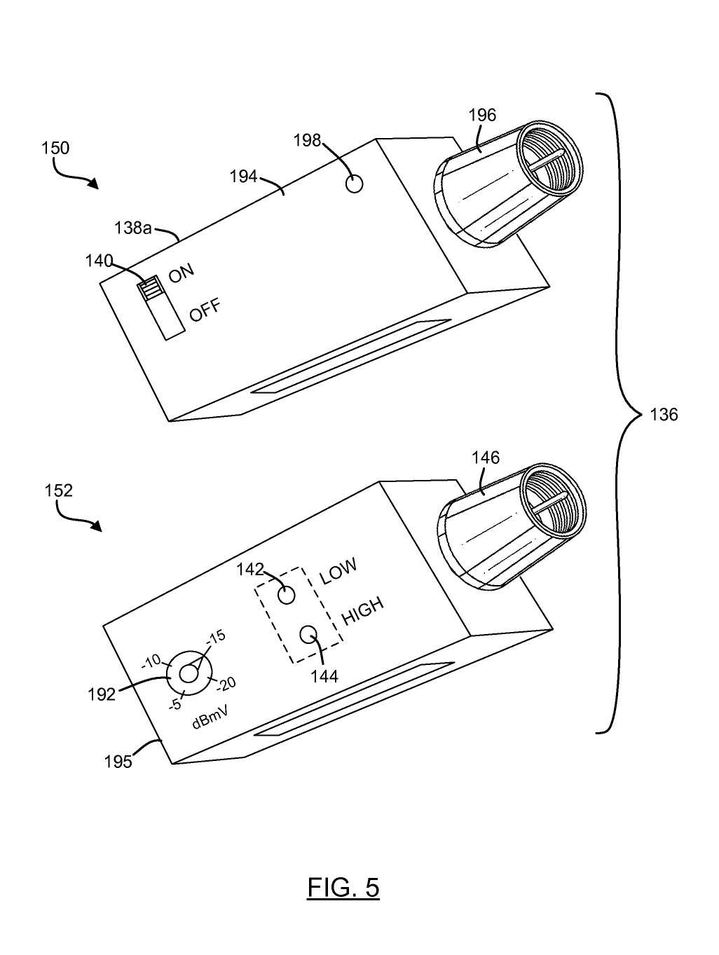

Referring to FIG. 5, another embodiment of the invention includes a two-piece diagnostic device 136. The first element in the device 136 comprises a radio frequency injection circuit 150, and the second element comprises a receiver test circuit 152. In contrast to the previous embodiment in which the test signal reflected off devices in the subscriber drop system and the reflected signal was subsequently detected, the embodiment illustrated in FIG. 5 directly detects the insertion loss caused by other devices within the home network.

The radio frequency injection circuit 150 may include a housing 194 and a connector 196. The housing 194 can be formed of a hard impact-resistant material, plastic or polymer, or a hard electrically insulating material. In the illustrated embodiment, the connector 196 is a male coaxial fitting suitably adapted to plug into a distribution port of the subscriber's drop system. The injection circuit 150 further includes a power switch 140 to power the internal electronics such as the RF injection circuitry, and may include an LED-type indicator lamp 198 to identify when the power is active.

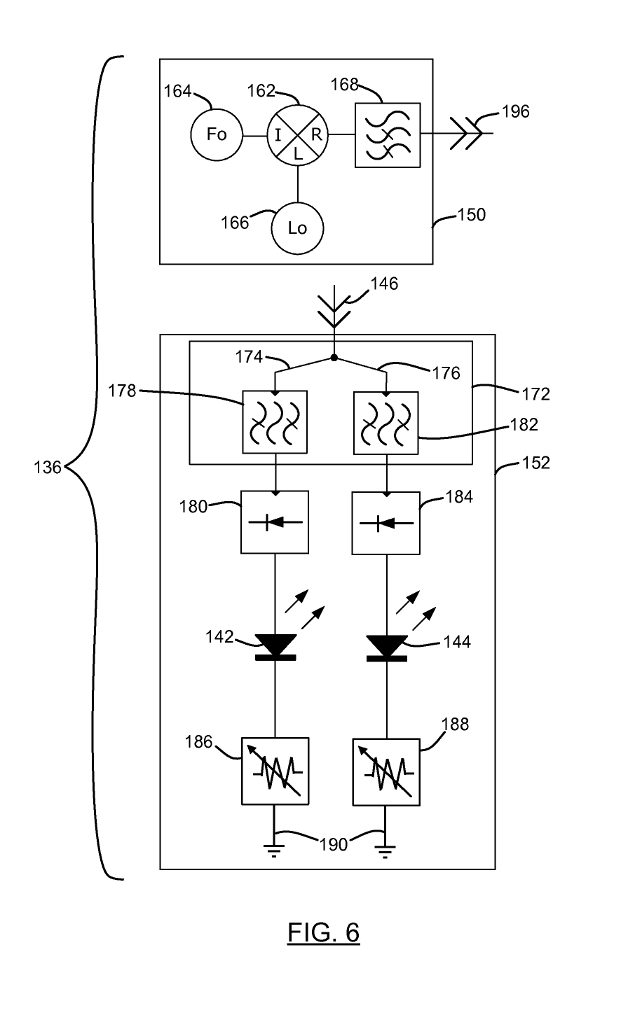

Referring to FIG. 6, wherein a schematic circuit diagram of the injection circuit 150 is shown, a signal generator 162 is arranged and configured to output an RF signal that includes the home network bandwidth. In one embodiment, the signal generator 162 is a mixer wherein a first input signal 164 and a second input signal 166 are multiplied and the output passes through a high pass filter 168. One skilled in the art would appreciate that more than two inputs may be utilized in order to obtain the desired RF signal output in the home network bandwidth. The high pass filter 168 is configured to pass only the home network frequency range and attenuate any frequencies below the home network frequency range. In one example, the first input signal 164 to the signal generator 162 is approximately 1545 MHz (or a multiple thereof), and the second input signal 166 is approximately 440 MHz, and the high pass filter 168 passes RF signals in a range from 1125 MHz to 1525 MHz. The output of the high pass filter 168 propagates through the second connector 196 and is injected directly into the subscriber drop system. In one example, the radio frequency injection circuit 150 is connected to distribution port 26a (FIG. 1).

Referring back to FIGS. 5 and 6, the receiver test circuit 152 is adapted to receive the high frequency output of the radio frequency injection circuit 150 that is transmitted through the subscriber drop system. The strength of the incoming signal is a direct consequence of the loss between the injection point and the receiver location. As previously noted with reference to FIG. 2, significant signal degradation may occur across a conventional splitter in the home network frequency band. There, the transmitted power decreased by approximately 3 dB, or 50%, up to approximately 1260 MHz. Thereafter, the transmitted power decreased by as much as 20 dB, or 99%.

The decrease in transmitted power, or insertion loss, may also be expressed in terms of a voltage that is transmitted through the circuit. In one embodiment, the radio frequency injection circuit 150 injects a test signal at a known power and frequency range. The receiver test circuit 152 receives the test signal at a second, lower power due to the losses in the coaxial line such as splitters and the like. The receiver test circuit 152 is configured to determine if sufficient power is present to properly operate a home network-enabled device across the entire home network bandwidth. One means to accomplish this is to convert the test signal to a DC voltage. Referring to FIGS. 5 and 6, the test signal propagates in a downstream direction through a connector 146, and passes to a diplexer circuit 172 configured to split the incoming signal to a first test path 174 and a second test path 176. The diplexer circuit 172 includes a first band pass filter 178 disposed on the first test path 174. The first band pass filter 178 is configured to pass only the frequencies on the low end of the home network bandwidth. For example, the first band pass filter 178 may pass frequencies in the range of 1000 MHz to 1125 MHz. The output of the first band pass filter 178, if present after filtering, is connected to a first rectifier 180, such as a log detector or peak detector, for conversion to a DC voltage. The DC voltage, if present, changes the state of a first indicator 142 to signify the presence of the low end of the home network bandwidth in the signal that was propagated downstream from an upstream port. In one example, the first indicator 142 is a light-emitting diode (LED).

The incoming signal from the connector 146 also propagates along the second test path 176 to a second band pass filter 182. The second band pass filter 182 is configured to pass only the frequencies on the high end of the home network bandwidth. For example, the second band pass filter 182 may pass frequencies in the range of 1525 MHz to 1600 MHz. The output of the second band pass filter 182, if present, is connected to a second rectifier 184, such as a log detector or peak detector, for conversion to a DC voltage. The DC voltage, if present, changes the state of a second indicator 144 to signify the presence of the high end of the home network bandwidth in the signal that was reflected from an upstream port. In one example, the second indicator 144 is a light-emitting diode (LED).

The receiver test circuit 152 may include a hand-held housing 195 with two LED indicator lights 142, 144 respectively, and an external selector 192 on the housing allows the diagnostic device 136 to be set for a particular voltage by varying resistance values. The housing 195 can be formed of a hard impact-resistant material, plastic or polymer, or a hard electrically insulating material. The coaxial connector 146 electronically couples the receiver test circuit 152 to an active port within the subscriber drop system when the injection circuit 150 is connected upstream. In the example wherein the radio frequency injection circuit 150 is connected to distribution port 26a (FIG. 1), the coaxial connector 146 may be connected to distribution port 26e in one embodiment of the invention.

As explained above with reference to the one-piece housing, the receiver test circuit 152 can be adapted to test for different voltage values. The first test path 174 and the second test path 176 may include variable resistor elements 186, 188 respectively disposed adjacent an electrical ground 190. The resistance setting may be referenced to the desired threshold voltage value. The external selector 192 on the housing 195 allows the diagnostic device 136 to be set for a particular voltage by varying the resistance values. In another embodiment, the selector 192 may be utilized to detect the threshold (i.e., minimum) voltage available to the distribution port of the splitter. For example, the device 136 may be used to ascertain whether the entire home network bandwidth is available at −5 dBmV at the splitter port, or a value much less, such as −20 dBmV. In either example, an affirmative result would illuminate both indicators 142, 144.

Other injection locations are contemplated within the scope of the invention. One such example may be envisioned in a subscriber drop system comprising several splitters and a network of coaxial cable that branches off each splitter and is directed to other rooms in a household. A first piece of customer premises equipment (such as a MoCA-enabled set top box) may be located in one room of the house, and a second piece of customer premises equipment (such as a MoCA-enabled digital video recorder) may be located in another room of the house. The user may connect the radio frequency injection circuit to the distribution port at the set top box location and measure the insertion loss of the home network bandwidth at the digital video recorder location.

One advantage of the disclosed diagnostic device is the simple construction and ease of use. In one embodiment, the device is a one-piece unit that may be connected to the coaxial distribution port to which the home network-enabled device will be connected. When the LEDs are illuminated, the loss between the home network-enabled devices is acceptable for the device to work properly. A condition in which the LEDs do not illuminate alerts the user that further troubleshooting in the home network bandwidth is required.

In another embodiment, the diagnostic device is a two-piece unit that may be installed in the subscriber drop system. The two-piece diagnostic device allows a direct measurement of the signal strength in the home network bandwidth, as opposed to a reflected strength, by utilizing insertion loss characteristics.

Both the one-piece and the two-piece diagnostic devices allow the user to determine if a given distribution port in their drop system will properly transmit content in the home networking bandwidth. The determination may be made without the use of complex meters or special knowledge of coaxial installations. One aspect of the invention allows the user to ascertain whether the home network signal is sufficient even if roll-off is present due to conventional devices in the drop system. In other words, even if some home network signal degradation is present, the disclosed diagnostic device will allow the user to determine if the signal is still adequate for a particular home network-enabled device. If not, remediation may be required such as installing amplifiers or home network-certified splitters that do not degrade signals in the home network bandwidth.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

I claim:

1. A one-piece home network bandwidth diagnostic device comprising:
a housing;
a coaxial connector portion secured to the housing adapted to electronically couple the diagnostic device to an active distribution port within a subscriber drop system;
a radio frequency injection circuit coupled to the coaxial connector comprising a signal injector configured to inject a radio frequency test signal at a first power level substantially to the subscriber drop system, the test signal defined by a lower home network frequency and an upper home network frequency;
a receiver test circuit having a diplexer circuit coupled to the coaxial connector, an input of the diplexer circuit configured to accept the radio frequency test signal at a second, lower power level, an output of the diplexer circuit comprising a first test path to pass substantially only the lower home network frequency, and a second test path to pass substantially only the upper home network frequency;
a first indicator disposed on the first test path configured to change state when the first power level is greater than a threshold value;
a second indicator disposed on the second test path configured to change state when the second power level is greater than the threshold value; and
a power switch coupled to the radio frequency injection circuit for transmitting a test signal.

2. The diagnostic device of claim 1, wherein the signal injector comprises a directional coupler.

3. The diagnostic device of claim 2, wherein the radio frequency injection circuit further comprises a signal generator having two inputs and an output, the output including a radio frequency bandwidth that includes a home network bandwidth.

4. The diagnostic device of claim 3, further comprising a high pass filter disposed between the signal generator and the directional coupler, the high pass filter configured to pass the home network bandwidth to the directional coupler and substantially attenuate frequencies below that of the home network bandwidth.

5. The diagnostic device of claim 1, wherein the first test path comprises a first band pass filter and a first rectifier, an output of the first band pass filter being converted by the first rectifier to a direct current voltage, the first indicator configured to change state when the voltage is greater than a threshold value.

6. The diagnostic device of claim 5, wherein the output of the first band pass filter is configured to pass a frequency range on the lower portion of the home network bandwidth.

7. The diagnostic device of claim 6, wherein the lower portion of the home network bandwidth is in the range of 1000 MHz to 1125 MHz.

8. The diagnostic device of claim 1, wherein the second test path comprises a second band pass filter and a second rectifier, an output of the second band pass filter being converted by the second rectifier to a direct current voltage, the second indicator configured to change state when the voltage is greater than a threshold value.

9. The diagnostic device of claim 8, wherein the output of the second band pass filter is configured to pass a frequency range on the upper portion of the home network bandwidth.

10. The diagnostic device of claim 9, wherein the upper portion of the home network bandwidth is in the range of 1525 MHz to 1600 MHz.

11. The diagnostic device of claim 1, wherein the first test path further comprises a first variable resistor element, the second test path further comprises a second variable resistor element, and the housing comprises a selector coupled to the first and second variable resistor element, the selector adapted to vary a resistance value of the first and second variable resistor elements.

12. A two-piece home network bandwidth diagnostic device comprising:
a first housing comprising a coaxial connector portion adapted to electronically couple a radio frequency injector circuit to a first distribution port within a subscriber drop system, the radio frequency injector circuit configured to inject a radio frequency test signal at a first power level to the first distribution port, the test signal defined by a lower home network frequency and an upper home network frequency, the first housing further comprising a power switch coupled to the radio frequency injection circuit for transmitting the test signal; and
a second housing comprising a coaxial connector portion adapted to electronically couple a receiver test circuit to a second distribution port within the subscriber drop system, the receiver test circuit comprising a diplexer circuit coupled to the coaxial connector portion, an input of the diplexer circuit configured to accept the radio frequency test signal at a second, lower power level, an output of the diplexer circuit comprising a first test path to pass substantially only the lower home network frequency, and a second test path to pass substantially only the upper home network frequency, the receiver test circuit further comprising a first indicator disposed on the first test path configured to change state when the second power level is greater than a threshold value, and a second indicator disposed on the second test path configured to change state when the second power level is greater than the threshold value.

13. The two-piece diagnostic device of claim 12, wherein the radio frequency injection circuit further comprises a signal generator having two inputs and an output, the output including a radio frequency bandwidth that includes a home network bandwidth.

14. The two-piece diagnostic device of claim 13, further comprising a high pass filter disposed between the signal generator and the coaxial connector portion of the first housing, the high pass filter configured to pass the home network bandwidth to the coaxial connector and substantially attenuate frequencies below that of the home network bandwidth.

15. The two-piece diagnostic device of claim 12, wherein the first test path of the output to the diplexer circuit comprises a first band pass filter and a first rectifier, an output of the first band pass filter being converted by the first rectifier to a direct current voltage, the first indicator configured to change state when the voltage is greater than a threshold value.

16. The two-piece diagnostic device of claim 15, wherein the output of the first band pass filter is configured to pass a frequency range on the lower portion of the home network bandwidth.

17. The two-piece diagnostic device of claim 16, wherein the lower portion of the home network bandwidth is in the range of 1000 MHz to 1125 MHz.

18. The two-piece diagnostic device of claim 12, wherein the second test path of the output to the diplexer circuit comprises a second band pass filter and a second rectifier, an output of the second band pass filter being converted by the second rectifier to a direct current voltage, the second indicator configured to change state when the voltage is greater than a threshold value.

19. The two-piece diagnostic device of claim 18, wherein the output of the second band pass filter is configured to pass a frequency range on the upper portion of the home network bandwidth.

20. The two-piece diagnostic device of claim 19, wherein the upper portion of the home network bandwidth is in the range of 1525 MHz to 1600 MHz.

21. The two-piece diagnostic device of claim 12, wherein the first test path of the output to the diplexer circuit further comprises a first variable resistor element, the second test path of the output to the diplexer circuit further comprises a second variable resistor element, and the second housing further comprises a selector coupled to the first and second variable resistor element, the selector adapted to vary a resistance value of the first and second variable resistor elements.
